(19) United States
(12) Patent Application Publication
(10) Pub. No.: US 2003/0027884 A1
(43) Pub. Date: Feb. 6, 2003

(54) Binder composition for photocatalytic coating and photocatalytic coating film manufactured using the same

(76) Inventors: Seong-Kil Kim, Kyunggi-Do (KR); Hee-Dong Jang, Daejeon (KR); Kyung-Ik Lee, Chunggcheongnam-Do (KR); Hong-Soo Park, Kyunggi-Do (KR)

Correspondence Address: Michael A. Cantor, Philmore H. Colburn II, 55 Griffin South Road, Bloomfield, CT, 06002, US

(21) Appl. No.: 09/912,118

(22) Filed: Jul. 24, 2001

(30) Foreign Application Priority Data
May 18, 2001 (KR) 2001-27401

(51) Int. Cl. C09D 133/16; C08K 3/00; C09D 143/04; C08J 3/00

(52) U.S. Cl. 522/81; 522/182; 522/172; 522/84; 524/805; 524/806

(57) ABSTRACT

A binder composition for a photocatalytic coating is disclosed. The binder composition comprises 60-80 wt. % of a first monomer which is a non-fluoro containing monomer selected from the group consisting of acrylic monomers, methacrylic monomers, and mixtures thereof, having an aliphatic group and 20-40 wt. % of a second monomer which is at least one monomer selected from the group consisting of a fluoro containing monomer and a silicone monomer. The fluoro containing monomer is selected from the group consisting of styrene monomer, acrylic monomer and methacrylic monomer.

### BACKGROUND OF THE INVENTION

1. Field of the Invention

The present invention relates to a photocatalytic coating and, more particularly to a binder composition for a photocatalytic coating and a photocatalytic coating film manufactured using the composition, which can enhance a photocatalytic activity to remove pollutants by maximizing a photocatalysis by a photocatalyst while being effectively protected from the photocatalyst, thereby improving a weather resistance of the photocatalytic coating film.

2. Description of the Related Art

In recent, a photocatalytic coating has been used to increase a weather resistance of a coated film and remove adsorbed contaminants and prevent the contaminants' adsorption for anti-fouling and self-cleaning purposes. Particularly, it is well known that titanium dioxide as a white pigment which is usually used in a process for producing a paint has a photocatalytic property.

The titanium dioxide is classified into two types, i.e. anatase-type and rutile-type, in view of its crystalline structure. Rutile-type titanium dioxide is widely used as a white pigment, because it has excellent shielding property when thinly coated with a porous composition containing alumina, silica, and the like, in order to mask the photoactivity of the pigment particles. Further, anatase-type titanium dioxide is predominantly used as a photocatalyst, and initiates a photocatalytic reaction on absorbing ultra-violet(UV) light. A transmittance distance of the anatase-type titanium dioxide is 4.3 times longer than that of the rutile-type titanium oxide.

When manufacturing a coating by using a photocatalyst comprising the titanium dioxide, the resultant coating has an enhanced anti-fouling properties, but the coating surface can be discolored, so called, “yellowing”, in a short time, since a binder which is a common organic compound contained in the photocatalytic coating is decomposed due to a strong oxidation of the photocatalyst.

Accordingly, compounds which cannot be readily decomposed even by the oxidation of the photocatalyst, are used as a binder. Examples of the non-oxidizable binder include polysiloxane, fluorine resin, colloidal silica, silica sol, alumina sol, metal alkoxide, alkali silicate, organic silicate, and the like.

Particularly, U.S. Pat. Nos. 5,755,867 and 5,849,200 directed to a binder of photocatalytic coating disclose a binder comprising a silicone resin as a main component. When the binder is used for photocatalytic coating, hydrophilic and anti-fouling properties can be enhanced.

However, since an excessive amount of a photocatalyst is normally used in order to increase a photocatalytic activity in the photocatalytic coating, coating defects such as crack or secession are generated in a short time. Particularly, repair coatings or replacement of coatings are needed, since weather resistance is deteriorated due to a decomposition of the binder by strong oxidation of photocatalyst when exposed to UV light.

Accordingly, in recent years, photocatalytic coating for improving anti-fouling and weather resistance has been highly required. As a result of the present inventors' earnest studies for obtaining such a photocatalytic coating, the present inventors have accomplished the present invention.

Therefore, the object of the present invention is to provide a binder composition for photocatalytic coating and a photocatalytic coating manufactured using the composition, which exhibits enhanced photocatalytic activity and weather resistance, and decomposition of the binder by a photocatalyst is prevented.

### SUMMARY OF THE INVENTION

The object of the present invention can be accomplished by providing a binder composition for photocatalytic coating comprising 60-80 wt. % of a first monomer which is a non-fluoro containing monomer selected from the group consisting of acrylic monomers, methacrylic monomers, and mixtures thereof, having an aliphatic group, and 20-40 wt. % of a second monomer which is at least one monomer selected from the group consisting of a fluoro containing monomer and a silicone monomer, the fluoro containing monomer being selected from the group consisting of styrene monomer, acrylic monomer and methacrylic monomer.

The present invention also provide a method for more effectively producing a binder for a photocatalytic coating, comprising: adding 60-80 wt. % of a first non-fluoro containing monomer selected from the group consisting of acrylic and methacrylic monomers having an aliphatic group, 20-40 wt. % of a second monomer selected from a fluoro containing monomer and a silicone monomer, the fluoro containing monomer being selected from the group consisting of styrene, acrylic and methacrylic monomers, and the amount being based on the total weight of the monomer mixture, and a reaction initiator in an amount of 0.5-1.5 wt. % based on the total weight of the monomer mixture, to deionized water at a temperature of 60-80° C., and polymerizing a resultant mixture at the same temperature.

### DESCRIPTION OF THE PREFERRED EMBODIMENT

The binder composition for photocatalytic coating according to the present invention will be explained with respect to the process for producing the binder composition as below.

Radical polymerization of the monomer mixture in the deionized water using a reaction initiator produces the binder composition according to the present invention. The monomer mixture includes a first monomer of a non-fluoro containing monomer and a second monomer which is at least one of a fluoro containing monomer and a silicone monomer. Based on the total weight of the monomer mixture, the first monomer is included in 60-80 wt. %, and the second monomer is included in 20-40 wt. %. The non-fluoro containing monomer includes at least one of acrylic monomer and methacrylic monomer having an aliphatic group. The second monomer includes at least one of a fluoro containing monomer and silicone monomer. The fluoro containing monomer includes styrene monomer, acrylic monomer and methacrylic monomer.

The amount of the first non-fluoro containing monomer having aliphatic group used in the present invention may be added as usually used in a process for producing a conventional binder composition. However, it is preferable to use 60-80 wt. % based on the total weight of the monomer mixture.

Examples of the non-fluoro containing monomer includes ethyl acrylate, methyl acrylate, n-butyl acrylate, 2-ethylhexyl acrylate, n-butyl methacrylate, n-propyl methacrylate, methyl methacrylate, ethyl methacrylate, 2-ethylhexyl methacrylate, octyl methacrylate, glycidyl methacrylate, lauryl methacrylate, isobonyl methacrylate and the like. These compounds may be used in combination with at least one of these compounds.

One aspect of the present invention is to add a second monomer which is at least one of fluoro containing monomer and silicone monomer. The fluoro containing monomer includes at least one of styrene, acrylic and methacrylic monomers.

The fluoro containing monomer is used in order to increase a hardness and a weather resistance of a coating.

Examples of the fluoro containing monomer includes 1,2,2-trifluorostyrene, 2-fluorostyrene, 3-fluorostyrene, 4-fluorostyrene, trifluoroethyl methacrylate, 2,2,3,3-tetrafluoropropyl methacrylate, 2,2,3,4,4,4-hexafluorobutyl methacrylate, perfluorooctylethyl methacrylate, perfluorooctylethyl acrylate, hexafluoro-2-(4-fluorophenyl)-2-propyl acrylate, hexafluoro-2-(4-fluorophenyl)-2-propyl methacrylate, 1,1-dihydroperfluoroheptyl acrylate and 1,1-dihydroperfluorooctyl acrylate, and the like. These compounds may be used in combination with at least one of these.

Since a silicone monomer renders the coating surface hydrophilic, it prevents particulate adhesive materials mainly consisting of carbon such as exhausted gases, tire-abrasive material, soot and smoke, as pollutants from chemically or physically adhering and fixing to the coating surface. In addition, the silicone monomer increases a crosslinking density of the coating, and thus prevents pollutants from permeating into the coating. Further, although the coating surface is polluted by particulate adhesive materials, the pollutants are readily removed by rain.

Examples of the silicone monomer include methacrylatoalkylalkoxysilane compounds such as 3-methacryl oxypropyltriisopropoxysilane, 3-methacryloxy propyltriiso butoxysilane and 3-methacryloxy propyltrioctoxysilane, which exhibit a high reactivity with acrylic or methacrylic monomer and have silyl ester group as a terminal group; or vinylalkoxysilane such as vinyl triisobutoxysilane, vinyltri-n-decoxysilane or vinyltri-t-butoxysilane. These compounds may be used in combination with at least one of these. In addition, these compounds may be also used together with 3-mercaptopropyltriisobutoxysilane, 3-mercapto propyltrimethoxysilane, and the like, which serve as a chain transfer agent. It is preferable to selectively use the alkoxysilane exhibiting a high steric hindrance effect, which is desirable in view of reaction stability and storage stability.

When the fluoro containing monomer is used in an amount of less than 20 wt. % based on the total weight of the monomer mixture, hardness and weather resistance properties of the coating are deteriorated. Meanwhile, when the amount of the fluoro containing monomer exceeds 40 wt. %, a reactivity and adhesion with respect to a substrate can be deteriorated. Accordingly, it is preferable to use the fluoro containing monomer within the specified range.

When the silicone monomer is used in the amount of less than 20 wt. % based on the total weight of the monomer mixture, anti-fouling and weather resistance properties of the coating are deteriorated.

Meanwhile, when the amount of the silicone monomer exceeds 40 wt. %, a viscosity increases thereby deteriorating a storage stability. Accordingly, it is preferable to use the silicone monomer within the range of 20-40 wt. % based on the total weight of the monomer mixture.

Similarly, it is preferable to maintain the sum amount of the fluoro containing monomer and the silicone monomer, when they are used together, in the range of 20-40 wt. % of the total weight of the mixture.

Since both silicone monomer and fluoro containing monomer are strongly hydrophobic and are different in electrical property, the mixture of their non-compatible monomers may cause a phase separation. However, when silicone monomer and fluoro containing monomer are polymerized to produce a copolymer, the phase separation is avoided. Further, the copolymer shows enhanced properties, that is, anti-fouling and weather resistance properties are enhanced compared with a homopolymer consisting of only one of the monomers.

The anti-fouling property is evaluated based on the following principle. Considering a sliding-off property of water drop on a polymer surface according to the Molecular Orbit Theory stipulating a molecular alignment and an interaction energy among molecules in the closest position, when water contacts a surface of a material, a hydrophilic group does not approach and repel water molecule due to a reciprocal action of static electricity, since the hydrophobic surface is charged with negative (−), and the vicinity of the surface of water drop and the material are charged with positive (+). In other words, since adhesion with the water drop is lowered, the water drop is readily slid-off, and thus preventing pollution. This reaction occurs in hydrophobic molecules having a hydrophilic group, for example in the copolymer of fluorine and silicone or the polymer having the hydrophilic and hydrophobic surface, when a slight amount of hydrophilic group is present in the hydrophobic group of the copolymer. Accordingly, the water drop is readily slid-off to exert the anti-fouling property on the coating surface. Therefore, a photocatalytic coating which is basically different from a conventional anti-fouling coating can be obtained.

As described in the above, an emulsion-type binder composition for photocatalytic coating according to the present invention can be produced by dropwise adding the first monomer of non-fluoro containing monomer and the second monomer which is at least one of the fluoro containing monomer and silicone monomer. A conventional reaction initiator may be used. Deionized water is used as a reaction medium. The addition is performed at a temperature of 60-80° C., preferably, 60˜65° C., for 3 to 5 hours, and the mixture is kept for further 2 to 3 hours for polymerization.

In the above process, the reaction initiator is added in order to regulate a molecular weight of the binder composition and to initiate the polymerization. The initiator may be added within the usual amount, but is preferably used in the amount of 0.5˜1.5 wt. % based on the total weight of the monomer mixture.

The reaction initiator includes an oxidant and a reducing agent. Examples of the oxidant include water-soluble peroxides such as potassium persulfate, ammonium persulfate, sodium persulfate, potassium permanganate, tertiary butyl hydroperoxide, cumene hydroperoxide and diisopropylbenzene hydroperoxide. Examples of the reducing agent include sodium methabisulfite, sodium hydrosulfite, sodium sulfide, sodium thiosulfate, hydrazine hydrate, sodium formaldehyde sulfoxylate, ferrous sulfate, and the like. The said oxidant and reducing agent as a radical polymerization initiator may be used in alone or in combination with at least two compounds.

The radical process using the initiator is mainly classified into an oxidizing system and a redox system. The oxidizing system uses only oxidant as a reaction initiator generally at a temperature of about 80° C. On the other hand, the redox system uses both the oxidant and the reducing agent as a reaction initiator at the same time at a relatively low temperature of about 60° C.

When the radical process is initiated by using the redox system, an emulsion resin having a core-shell structure and a different interior and exterior structure is produced. The resultant resin composition having the core-shell structure is advantageous in that a coating having a high hardness even at the low temperature can be obtained.

That is to say, the emulsion binder composition having the core-shell structure for photocatalytic coating can be produced by dropwise adding the monomer mixture in a different proportion to the deionized water in two steps. The first step is initiated by adding the oxidant and the reducing agent as a reaction initiator, and the second step is initiated by adding only reducing agent as a reaction initiator.

It is preferable to add the reactive emulsifier having a high water-resistance in order to stabilize the synthetic resin composition. The reactive emulsifier has an unsaturated bond in its molecule, and is commonly used as a surface-active monomer, which is soluble in a continuous-phase polymer.

When the resin composition for a photocatalytic binder is produced by the above method, the composition has a glass transition temperature (Tg) of +5˜30° C., viscosity of 50˜90 KU, and not less than 45% of non-volatile components.

When the binder composition for photocatalytic coating produced by the above method is used for a photocatalytic coating, there can be obtained the coating having excellent weather resistance and anti-fouling properties while sufficiently retaining inherent properties of a photocatalyst since the decomposition of the binder by the photocatalyst is prevented.

Namely, when 100 parts by weight of the binder composition and 20˜30 parts by weight of a conventional photocatalyst are mixed with a thickener, a pigment and other additives in commonly used amounts, a resultant photocatalytic coating has excellent anti-fouling and weather resistance.

According to the present invention, there may be used photocatalysts produced by various methods. However, in the following examples, a particulate titanium dioxide (average particle size: 23 nm, anatase contents: 73%) was used, which was produced by a method of the co-pending Korean Patent application No. 2000-18311 filed by the present inventors titled “a process for preparing a nano-size titanium dioxide ultra fine particulate by the gaseous oxidation using a flame.”

The present invention is described in more detail by Examples and Comparative Examples, but the Examples are only illustrative and, therefore, not intended to limit the scope of the present invention.

### EXAMPLES

### Examples 1 to 9 and Comparative Examples 1-4

n-Butyl acrylate and methyl methacrylate as acrylic and methacrylic monomers having aliphatic group, methacrylic acid as methacrylic functional monomer, silicone monomer, and styrene monomer or acrylic or methacrylic monomer containing a fluorine component were uniformly mixed in the amounts as shown in Table 1 to give a mixture.

107.3 g of deionized water, 1.5 g of reactive emulsifier, and 0.4 g of sodium bicarbonate as buffer were introduced to a 4-necked flask equipped with a stirrer. The flask was purged with nitrogen gas, heated to a temperature of 50° C. while stirring. And then, 0.6 g of ammonium persulfate as a reaction initiator (oxidant), 1.2 g of sodium methabisulfite (5%) as a reducing agent, and 10% of core monomer mixture were added to the flask to initiate the reaction. After initiating the reaction, the rest 90% of the core monomer mixture and 4.8 g of sodium methabisulfite (5%) as a reducing agent were uniformly added dropwise to the flask for 2 hours at a temperature of 60° C., and then were aged further for 1 hour to synthesize a core emulsion. Subsequently, 1.2 g of sodium methabisulfite (5%) as a reducing agent and shell monomer mixture were uniformly added dropwise to the flask for 1 hour at the same temperature, and maintained for 1 hour. And then, the mixture of 0.05 g of tertiary butyl hydroperoxide and 1.2 g of sodium formaldehyde sulfoxylate (2%) was uniformly added dropwise to the flask for 30 minutes, was left them for 30 minutes. The mixture was adjusted to pH 7 with an aqueous ammonium hydroxide solution (25%) to produce the core-shell emulsion resin as a binder for photocatalyst containing 45% of non-volatile components.

### Comparative Examples 5 and 6

120.3 g of deionized water, 1.5 g of reactive emulsifier, and 0.4 g of sodium bicarbonate as buffer were introduced to a 4-necked flask equipped with a stirrer. The flask was purged with nitrogen gas, heated to a temperature of 70° C. while stirring. And then, 0.6 g of ammonium persulfate as a reaction initiator (oxidant) and 10% of core monomer mixture shown in Table 1 were added to the flask to initiate the reaction. After initiating the reaction, the rest 90% of the core monomer mixture was uniformly added dropwise to the flask for 2 hours at a temperature of 80° C., and then were aged further for 1 hour. And then, the mixture of 0.05 g of tertiary butyl hydroperoxide and 1.2 g of sodium formaldehyde sulfoxylate (2%) was uniformly added dropwise to the flask for 30 minutes, and was left them for 30 minutes. The mixture was adjusted to pH 7 with an aqueous ammonium hydroxide solution (25%) to produce the binder composition for photocatalyst containing 45% of non-volatile components.

TABLE 1

| | Core | | | | | | | | |
|---|---|---|---|---|---|---|---|---|---|
| | | | | fluorine | | Shell | | | |
| | n-butyl | methyl | methacry- | mono- | silicone | methyl | methacrylic | fluorine | silicone |
| | acrylate | methacry- | lic | mer | monomer | methacry- | acid | monomer | monomer |
| | (g) | late (g) | acid (g) | (g) | (g) | late (g) | (g) | (g) | (g) |
| Ex 1 | 38.2 | 16.8 | 1 | 4 | — | 20 | 4 | 16 | — |
| Ex 2 | 38.2 | 16.8 | 1 | — | 4 | 20 | 4 | — | 16 |
| Ex 3 | 38.2 | 16.8 | 1 | 2 | 2 | 20 | 4 | 8 | 8 |
| Ex 4 | 33.6 | 19.4 | 1 | 6 | — | 12 | 4 | 24 | — |
| Ex 5 | 33.6 | 19.4 | 1 | — | 6 | 12 | 4 | — | 24 |
| Ex 6 | 33.6 | 19.4 | 1 | 3 | 3 | 12 | 4 | 12 | 12 |
| Ex 7 | 28.9 | 22.1 | 1 | 8 | — | 4 | 4 | 32 | — |
| Ex 8 | 28.9 | 22.1 | 1 | — | 8 | 4 | 4 | — | 32 |
| Ex 9 | 28.9 | 22.1 | 1 | 4 | 4 | 4 | 4 | 16 | 16 |
| Comp. | 42.8 | 14.2 | 1 | 2 | — | 28 | 4 | 8 | — |
| Ex 1 | | | | | | | | | |
| Comp. | 42.8 | 14.2 | 1 | — | 2 | 28 | 4 | — | 8 |
| Ex2 | | | | | | | | | |
| Comp. | 24.3 | 14.7 | 1 | 10 | — | 6 | 4 | 40 | — |
| Ex 3 | | | | | | | | | |
| Comp. | 24.3 | 14.7 | 1 | — | 10 | 6 | 4 | — | 40 |
| Ex 4 | | | | | | | | | |
| Comp. | 28.9 | 26.1 | 5 | 20 | 20 | — | — | — | — |
| Ex 5 | | | | | | | | | |
| Comp. | 47.4 | 47.6 | 5 | — | — | — | — | — | — |
| Ex 6 | | | | | | | | | |

<Experiments>

20 g of particulate titanium dioxide (average particle size: 23 nm, anatase contents: 73%) and 0.1 g of surfactant were primarily dispersed in 40 g of deionized water. The dispersion was introduced to 100 g of the synthesized emulsion resin composition produced in Examples 1 to 9 and Comparative Examples 5 and 6, stirred at 500 rpm of rotating speed for 20 minutes, and treated with an ultrasonic washer for 10 minutes. 100 g of the above-obtained composition was added to 300 g of the paste which is dispersed in a solution of a white pigment (Dupont R-706) and a thickener solution while stirring at a rotating speed of 2000 rpm by a rapid stirrer for 20 minutes to produce a white photocatalytic paint containing 52% by weight of non-volatile matter.

In order to test the physical properties of the obtained coating, a tin-plated steel panel (KS D 3516) as a fragment was prepared according to KS M 5000-1112 relating to a method for manufacturing a tin plate for testing a coating. The panel was uniformly polished by using KS L 6004 No. 220 (water-resistant polishing paper) until a gloss appears, washed with a perchloroethylene containing no free-chlorine or chloric acid, and dried with hot air. The surface of the panel was sand-treated again by using KS L 6004 No. 600 (water-resistant polishing paper) at the room temperature, and coated with a room temperature-drying type inorganic two components type binder (manufactured by Technotrade Co. Heatless Glass) as base coat by using a bar coater #5 (wet coating thickness=11.43 μm). The coating was dried for 20 hours to obtain a fragment for test. The obtained fragment was coated with the photocatalytic coating produced in the above Experiment by using a bar coater #14 (wet coating thickness=32 μm), and dried at room temperature for 7 days. The physical properties of the coating were evaluated according to the following method. The result is represented in Table 2 as below.

Accelerated Pollution

In this accelerated pollution experiment, the accelerated pollution was evaluated with the difference between the brightness index before water-washing and the brightness index after water-washing by preparing a dispersion of 20% of black carbon dispersed in mineral spirit, spraying the dispersion on the fragment produced in the same process as the Experiment, and immersing and drying at the temperature of 80±2° C. for 5 hours. The lower the difference of the brightness index is, the higher the anti-fouling is.

Accelerated Weathering

In this accelerated weathering experiment, the accelerated weathering was evaluated with the gloss-retention value measured after exposing the fragment produced in the same process as the Experiment for 1,000 hours according to ASTM G 53 relating to an accelerated weathering test of the coating using UV-B lamp (280˜315 nm) and QUV tester (Q-Panel Co., accelerated weathering tester).

Adhesion

In this coating adhesion experiment, the adhesion was evaluated by counting the number of the pieces remaining in the 100 squares-separately formed coating surface, when 11 lines were vertically and horizontally (crosswise) drawn in a width of 1 mm on the dried coating surface of the fragment, a cellophane adhesive tape was adhered thereon, and the tape was removed therefrom, according to ISO 2409 relating to the coating adhesion test (cross-cut test).

Coating Film Hardness

Coating film hardness was evaluated by visually observing the extent of the scratch when coating the fragment with the coating in wet-film thickness of 0.076 mm, and scratching the dried coating film with the pencils (6B, 5B, 4B, 3B, 2B, B, HB, F, H, 2H, 3H, 4H, 5H, 6H, 7H, 8H, 9H) at the angle of 45°, according to JIS K-5400 (8.4.1) relating to pencil hardness method using a pencil hardness tester (“Serial No. 4664” manufactured by Yasuda Seiki Seisakusho Co., Ltd. in Japan).

Chalking

In this chalking test, the surface of the fragment in a distance of about 2˜3 inches (50˜70 mm) was rubbed in an adequate force with the black wool wrapped in a finger, according to Testing Method A of ASTM D4214 relating to cloth tape method. And then, the blots stained in the wool upon removing the wool from the coating surface were compared with the standard photographs defined according to ASTM D 659, and represented as no. 8, no. 6, no. 4 and no.2. In this test, no. 8 indicates the most excellent chalking, and no.2 indicates the worst chalking.

Photocatalysis

In this photocatalysis test, the fragment coated with the photocatalytic coating was immersed in a solution containing 0.001 mole of Methylene Blue (MB) for 20 minutes, and dried not in the direct ray. The photocatalytic property was evaluated by the decomposability of MB. The photocatalytic property was evaluated by radiating ultraviolet having 340 nm of wave length using a photocatalytic effect tester (“PCC-1” manufactured by Sinku-Riko Co., Ltd.), and measuring the amount of decomposition of MB in the coating surface after lapsing 20 minutes in a photo detector. The amount of decomposition of MB was represented as ΔABS of the below mathematics Formula 1:

$$Δ A B S = {b}_{2} ( \frac{{T}_{0}}{{T}_{1}} ) \qquad [ Formula 1 ]$$

b₂=transmittance coefficient

T₀=Initial transmittance

T₁=Momentary transmittance varying with the lapse of time.

Since MB is decomposed by the ultraviolet radiation in the initial transmittance, the transmittance is increased. As the absolute value increases forward the (−) direction, the photocatalytic property is excellent.

TABLE 2

| | Accelerated | Accelerated | Photocatalysis | Coating Film | | |
|---|---|---|---|---|---|---|
| | Pollution | Weathering | (Δ ABS) | Hardness | Adhesion | Chalking |
| Ex 1 | −2.5 | 93 | −0.1598 | B | 99/100 | 8 |
| Ex 2 | −2.8 | 91 | −0.1610 | 2B | 99/100 | 8 |
| Ex 3 | −2.5 | 92 | −0.1608 | B | 100/100 | 8 |
| Ex 4 | −2.0 | 94 | −0.1621 | HB | 98/100 | 8 |
| Ex 5 | −2.4 | 91 | −0.1619 | B | 99/100 | 8 |
| Ex 6 | −1.9 | 93 | −0.1625 | HB | 100/100 | 8 |
| Ex 7 | −1.7 | 96 | −0.1629 | F | 96/100 | 8 |
| Ex 8 | −2.0 | 92 | −0.1631 | HB | 97/100 | 8 |
| Ex 9 | −1.5 | 94 | −0.1644 | F | 100/100 | 8 |
| Comp. | −5.1 | 85 | −0.1573 | 4B | 98/100 | 4 |
| Ex 1 | | | | | | |
| Comp. | −4.8 | 83 | −0.1604 | 5B | 99/100 | 4 |
| Ex 2 | | | | | | |
| Comp. | −2.7 | 94 | −0.1607 | HB | 83/100 | 8 |
| Ex 3 | | | | | | |
| Comp. | −2.0 | 93 | −0.1622 | B | 85/100 | 8 |
| Ex 4 | | | | | | |
| Comp. | −2.7 | 89 | −0.0327 | B | 98/100 | 8 |
| Ex 5 | | | | | | |
| Comp. | −7.8 | 63 | −0.0423 | 6B | 100/100 | 2 |
| Ex 6 | | | | | | |

As is apparent from Table 2, when the second monomer selected from fluoro containing monomer and silicone monomer was used within the range of the present invention as shown in Examples 1 to 9, accelerated pollution, accelerated weathering, photocatalysis, coating film hardness, adhesion and chalking are excellent.

However, when the amount of the second monomer is less than the lower limit of the present invention as shown in Comparative Examples 1 and 2, accelerated pollution and accelerated weathering are poor, thereby resulting in poor chalking. Meanwhile, when the amount of the second monomer components is beyond the upper limit of the present invention as shown in Comparative Examples 3 and 4, adhesion is poor.

When it has a structure other than the core-shell structure in Comparative Example 5, the photocatalysis is lowered compared with Examples 1 to 9 of the present invention. Also, when the second monomer is not used in Comparative Example 6, accelerated pollution, accelerated weathering, photocatalysis, coating film hardness, and chalking are poor.

As stated in the above, the photocatalytic coating made using the binder composition according to the present invention exhibits the greatest photocatalytic activity and the excellent weather resistance while retaining a pollutants-decomposition property that a conventional photocatalytic coating has.

Particularly, since the novel binder composition according to the present invention has a core-shell structure formed by a redox process, it has an excellent photocatalysis while retaining the conventional chemical properties. Accordingly, although a small amount of the photocatalyst is used, the binder composition can exert the above effect in a desirable level. Therefore, the binder composition of the present invention is very useful in view of the productivity and the environmental affinity.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A binder composition for a photocatalytic coating comprising:
60-80 wt. % of a first monomer which is a non-fluoro containing monomer selected from the group consisting of acrylic monomers, methacrylic monomers, and mixtures thereof, having an aliphatic group; and
20-40 wt. % of a second monomer which is at least one monomer selected from the group consisting of a fluoro containing monomer and a silicone monomer, the fluoro containing monomer being selected from the group consisting of styrene monomer, acrylic monomer and methacrylic monomer.

2. The binder composition for photocatalytic coating according to claim 1, wherein the fluoro containing monomer is at least one compound selected from the group consisting of 1,2,2-trifluorostyrene, 2-fluorostyrene, 3-fluorostyrene, 4-fluorostyrene, trifluoroethyl methacrylate, 2,2,3,3-tetrafluoropropyl methacrylate, 2,2,3,4,4,4-hexafluorobutyl methacrylate, perfluorooctylethyl methacrylate, perfluorooctylethyl acrylate, hexafluoro-2-(4-fluorophenyl)-2-propylacrylate, hexafluoro-2-(4-fluorophenyl)-2-propylmethacrylate, 1,1-dihydroperfluoroheptyl acrylate and 1,1-dihydroperfluoro octyl acrylate.

3. The binder composition for photocatalytic coating according to claim 1, wherein the silicone monomer is at least one compound selected from the group consisting of methacrylatoalkylalkoxysilane compounds vinylalkoxysilane compounds and mercaptoalkylalkoxysilane compounds.

4. The binder composition for photocatalytic coating according to claim 3, wherein the methacrylatoalkylalkoxysilane compound is at least one selected from the group consisting of 3-methacryl oxypropyltriisopropoxysilane, 3-methacryloxypropyltriiso butoxysilane and 3-methacryloxypropyltrioctoxysilane.

5. The binder composition for photocatalytic coating according to claim 3, wherein the vinylalkoxysilane compound is at least one selected from the group consisting of vinyltriisobutoxysilane, vinyltri-n-decoxysilane and vinyltri-t-butoxysilane

6. The binder composition for photocatalytic coating according to claim 3, wherein the mercaptoalkyl alkoxysilane compound is at least one selected from the group consisting of 3-mercaptopropyltriisobutoxysilane and 3-mercaptopropyltrimethoxysilane.

7. A method for producing a binder for a photocatalytic coating, comprising:
adding 60-80 wt. % of a first non-fluoro containing monomer selected from the group consisting of acrylic and methacrylic monomers having an aliphatic group, 20-40 wt. % of a second monomer selected from a fluoro containing monomer and a silicone monomer, the fluoro containing monomer being selected from the group consisting of styrene, acrylic and methacrylic monomers, and the amount being based on the total weight of the monomer mixture, and a reaction initiator in an amount of 0.5-1.5 wt. % based on the total weight of the monomer mixture, to deionized water at a temperature of 60-80° C., and
polymerizing a resultant mixture at the same temperature.

8. The method for producing a binder for photocatalytic coating according to claim 7, wherein, during the adding, the temperature is maintained between 60-65° C.

9. The method for producing a binder for photocatalytic coating according to claim 8, wherein the adding is performed for 3 to 5 hours.

10. The method for producing a binder for photocatalytic coating according to claim 8, wherein the polymerizing reaction is performed for 2-3 hours.

11. The method for producing a binder for photocatalytic coating according to claim 7, wherein the adding includes adding an oxidant and a reducing agent as the reaction initiator with a portion of the first and second monomers, and adding a reducing agent as the reaction initiator with a remaining portion of the first and second monomer.

12. The method for producing a binder for photocatalytic coating according to claim 11, wherein the oxidant is at least one compound selected from the group consisting of potassium persulfate, ammonium persulfate, sodium persulfate, potassium permanganate, tertiary butyl hydroperoxide, cumene hydroperoxide and diisopropylbenzene hydroperoxide, and the reducing agent is at least one compound selected from the group consisting of sodium methabisulfite, sodium hydrosulfite, sodium sulfide, sodium thiosulfate, hydrazine hydrate, sodium formaldehyde sulfoxylate and ferrous sulfate.

13. The method for producing a binder for photocatalytic coating according to claim 11, wherein the binder is an emulsion type having a core-shell structure.

14. A photocatalytic coating produced from a photocatalyst and a binder produced in claim 4, the amount of the photocatalyst being 10-30 wt. % based on the weight of the binder.

15. The photocatalytic coating of claim 14, wherein the photocatalyst is titanium dioxide.
